(19) United States
(12) Patent Application Publication
(10) Pub. No.: US 2023/0160405 A1
(43) Pub. Date: May 25, 2023

(54) QUICK-ACTION CLAMPING APPARATUS, PELLETIZING APPARATUS HAVING SUCH A QUICK-ACTION CLAMPING APPARATUS, RELATED BRACING METHOD

(71) Applicant: NORDSON CORPORATION, WESTLAKE, OH (US)

(72) Inventor: Nikolai SCHNELLBACH, Senden (DE)

(21) Appl. No.: 17/922,395

(22) PCT Filed: May 18, 2021
(86) PCT No.: PCT/US2021/032854

§ 371 Date: Oct. 31, 2022

(30) Foreign Application Priority Data
May 27, 2020 (EP) 20176919.7

(51) Int. Cl. F16B 2/18

(52) U.S. Cl. CPC F16B 2/185; B29B 9/065

(57) ABSTRACT

The invention concerns a quick-action clamping apparatus (8, 108), in particular a one-hand quick-action clamping apparatus (8, 108), for clamping a first assembly (36, 136) of a pelletizing apparatus (2, 102) to a second assembly (38, 138) of the pelletizing apparatus (2, 102), in particular a pelletizer (4, 104) to a cutting chamber (6, 106). According to the invention there is proposed a mounting element (44, 144) which is arranged at the first assembly (36, 136) or the second assembly (38, 138), a locking element (40, 140) which is arranged at the other of the first assembly (36, 136) or the second assembly (38, 138), and a clamping means (10, 110) having a clamping element (32, 132), wherein the clamping element (32, 132) is mounted rotatably about an axis of rotation (D) to the mounting element (44, 144) and the clamping element (32, 132) is adapted to be pivoted into a clamping position (S) in which the clamping element (32, 132) is in engagement with the locking element (40, 140) and braces the first assembly (36, 136) against the second assembly (38, 138). The invention further concerns a pelletizing apparatus (8, 108) and a method of bracing a pelletizer (4, 104) to a cutting chamber (6, 106).

### CROSS REFERENCE TO RELATED APPLICATIONS

This application is a National Stage Application of International Patent App. No. PCT/US2021/032854, filed May 18, 2021, which claims the benefit of European Patent Application No. 20176919.7, filed May 27, 2020, the entire disclosures of both of which are hereby incorporated by reference as if set forth in their entirety herein.

### TECHNICAL FIELD

The invention concerns a quick-action clamping apparatus, in particular a one-hand quick-action clamping apparatus, for clamping a first assembly of a pelletizing apparatus to a second assembly of the pelletizing apparatus, in particular a pelletizer to a cutting chamber or a cutting chamber to an apertured plate, a bracing method and a clamping lever.

### BACKGROUND

Clamping apparatuses for bracing assemblies of a pelletizing apparatus, in particular a pelletizer with a cutting chamber or a cutting chamber with an apertured plate are known from the state of the art.

In pelletizing apparatuses, the assemblies being the pelletizer and the cutting chamber, are typically designed to be separable from each other, in particular to be able to adapt the pelletizing apparatus to different materials to be processed and to facilitate cleaning and maintenance thereof. For that purpose, it has proven effective for the pelletizer to be arranged moveably, for example on a rail system, wherein the cutting chamber is usually arranged stationarily.

In that respect particular significance is attributed to securely connecting the components being the pelletizer and the cutting chamber in operation as, in operation of the pelletizing apparatus, high pressures occur, which urge the assemblies away from each other. To prevent that, clamping apparatuses are known from the state of the art.

Such clamping apparatuses usually have a plurality of closure clamping devices which are to be installed by an operator while at the same time the operator is pushing the pelletizer in the direction of the cutting chamber. Clamping apparatuses with closure clamping devices are also known, which are used for reversibly bracing a cutting chamber with an aperture plate of a pelletizing apparatus.

Although such closure clamping devices have proven effective for securely connecting the assemblies of a pelletizing apparatus, there is room for improvement.

### SUMMARY

A disadvantage with the structures previously known from the state of the art is in particular that the operator has to carry out a number of movement sequences and changes in position for example to push the pelletizer in the direction of the cutting chamber and then install the plurality of closure clamping devices.

With that background in mind the object of the invention is to develop a clamping apparatus of the kind set forth in the opening part of this specification such that the disadvantages encountered in the state of the art are overcome to the best possible extent. In particular the invention seeks to provide a clamping apparatus which facilitates coupling of the assemblies of a pelletizing apparatus and bracing thereof.

According to the invention in a clamping apparatus of the first-mentioned kind that object is attained by a mounting element which is arranged at the first assembly or the second assembly, a locking element which is arranged at the other of the first assembly or the second assembly, and a clamping means having a clamping element, wherein the clamping element is mounted rotatably about an axis of rotation to the mounting element and the clamping element is adapted to be pivoted into a clamping position in which the clamping element is in engagement with the locking element and braces the first assembly against the second assembly.

The invention makes use of the realization that the procedure involved in coupling and bracing the assemblies by means of the quick-action clamping apparatus according to the invention can be made significantly easier. In comparison with structures previously known from the state of the art only one single movement is required to move the clamping means into the clamping position and to securely brace the assemblies, in particular the pelletizer to the cutting chamber.

In an equally simple fashion, the braced state is to be reversed by a movement of the clamping means in the opposite direction so that the assemblies can be separated from each other in order for example to carry out maintenance tasks or the like.

A development of the invention provides that the quick-action clamping apparatus has a second mounting element arranged at the same assembly as the first mounting element, a second locking element arranged at the same assembly as the first locking element, wherein the clamping means has a second clamping element which is mounted rotatably about a second axis of rotation to the second mounting element and the second clamping element is adapted together with the first clamping element to be pivoted into the clamping position in which the second clamping element is in engagement with the second locking element.

Such a redundant provision of the essential components of the quick-action clamping apparatus, namely the mounting element, the locking element and the clamping element, has been found to be advantageous for enhancing operational reliability and security. If improbable failure of one of the components should occur the redundant design ensures that the assemblies of the pelletizing apparatus still remain securely connected together in operation thereof. In addition, the bracing operation as well as release of the clamping state can be easily effected by a single movement of the clamping means which is coupled to both clamping elements. The provision of a second clamping element moreover advantageously permits the uniform application of a clamping force for bracing the assemblies. That further affords a sealed connection between the assemblies, that is safeguarded in particular against the escape of fluid.

In a preferred embodiment the clamping means further has a clamping lever connected to the at least one clamping element for actuating the at least one clamping element. Such a clamping lever has been found to be particularly advantageous for applications in which coupling and bracing of the assemblies is effected manually by an operator. In dependence on the arrangement of the clamping lever it can be moved not only for bracing the components themselves but also for moving the pelletizer in the direction of the cutting chamber.

According to a preferred embodiment the at least one clamping element has a hooked portion, wherein the hooked portion is adapted upon the pivotal movement of the clamping element into the clamping position to come into engagement with the locking element and to brace the locking element against the clamping element in the clamping position. The hooked portion performs a dual function. On the one hand it ensures bracing of the locking element against the clamping element in the clamping position and further serves to press the assemblies against each other as soon as the hooked portion comes into engagement with the locking element. In that way the operator is supported not only when locking the assemblies but also when coupling the assemblies together prior to applying the bracing action.

Preferably the hooked portion has a hook bottom, wherein the hook bottom is of a configuration corresponding to an external cross-section of the locking element. In that way the hook bottom ensures the transmission of adequate clamping forces and in addition reliably holds the locking element in the clamping position.

A further development of the invention provides that the hooked portion has a first limb and a second limb, wherein the limbs extend from the hook bottom and form a hook mouth and wherein the hook mouth forms a free cross-section between the limbs, which enlarges from the hook bottom in the direction of the limbs.

Such a configuration for the limbs or the hook mouth has proven to be particularly advantageous in order to press the assemblies against each other as soon as the locking element comes into engagement with the hook mouth. In other words the locking element is guided by the geometry of the hook mouth to the clamping position, which makes it easier for the operator to carry out the operation of coupling the assemblies and permits both coupling and also subsequent clamping by means of a single movement of the clamping means or the clamping lever.

In a preferred development the first limb and/or the second limb has a thickening which is arranged adjacent to the hook bottom and is adapted to hold the locking element in the clamping position. The thickening in question is moved past by the locking element when the clamping means is pivoted into the clamping position and in the clamping position provides that the locking element is securely held in the region of the hook bottom and the clamping means remains securely in the clamping position without the application of a force thereto. In an alternative embodiment the limb is of an angled configuration, in particular with a shallow angle, such that it holds the locking element self-lockingly in the clamping position.

Preferably the clamping element further has an eccentric portion, the eccentric portion being of such a configuration that in the movement of the clamping element out of the clamping position the eccentric portion applies a force to the locking element which separates the first assembly from the second assembly. This preferred embodiment makes use of the realization that, in relation to pelletizing apparatuses, high forces are possibly to be applied to the pelletizer by the operator in order to separate it from the cutting chamber for performing maintenance tasks and the like. The eccentric portion provides that, in a movement of the clamping element out of the clamping position, a force which separates the assemblies from each other is applied to the locking element.

A further development of the invention provides that the eccentric portion has an area centroid corresponding to the axis of rotation of the clamping element. It is further preferred that one of the limbs is provided by the eccentric portion.

According to a preferred embodiment the eccentric portion, in that region of the limb, that is adjacent to the hook bottom, has a first radius in relation to the area centroid, that radius increasing with an increasing distance from the hook bottom along the limb, in particular linearly or non-linearly.

The operating force applied to the clamping means by the operator can be transmitted as desired, in dependence on the design configuration of the eccentric portion. Thus for example a slight increase in the radius along the limb or in other words a slight inclination of the eccentric portion provides that for a given distance of movement and a force for movement of the clamping means, a higher force is applied to the mounting element, but same is urged away from the axis of rotation of the mounting element only by a short distance. A greater inclination of the eccentric portion, with the same force applied to the clamping means and the same distance of movement, has the result that the locking element is urged further away from the axis of rotation, but only a lower force is transmitted to same.

In a preferred embodiment the locking element and/or the mounting element is in the form of a pin. In that case the locking element and the mounting element preferably involve the same geometry. That improves the interoperability of the components.

A development of the invention provides that the quick-action clamping apparatus has a drive device for driving the clamping means, wherein the drive device has or is formed from in particular at least one of the following: an electric motor, a hydraulic actuator or a pneumatic drive, in particular having a cylinder drive and/or a rotary drive. For application situations in which the assemblies are not to be manually coupled and/or braced it has proven to be advantageous to provide a drive device for driving the clamping means.

Preferably the quick-action clamping apparatus has a sensor device for sensing the position of the clamping means. In a preferred embodiment the sensor device is arranged at the pelletizer and/or is adapted to generate a signal when the clamping means is in the clamping position and/or is moved out of same.

In an alternative embodiment the sensor device is connected in signal-conducting relationship to a control device of the pelletizing apparatus, wherein the control device is adapted to stop the pelletizing apparatus when the clamping means if moved out of the clamping position. It is further preferred for the control device to be adapted to start the pelletizing apparatus after the clamping means has been moved into the clamping position.

In a further preferred configuration, the quick-action clamping apparatus has a locking means, in particular an electromechanical locking means, adapted to hold the clamping means in the clamping position and/or to release same from the clamping position. That prevents the clamping means being inadvertently moved out of the clamping position during operation of the pelletizing apparatus.

An advantageous development provides that the clamping lever has two spaced clamping lever limbs and a handle connecting the clamping lever limbs. The two clamping lever limbs provide a mechanically particularly strong and reliable holding action and the quick-action clamping apparatus can be very easily and efficiently operated by means of the handle.

It is advantageous in regard to a compact but nonetheless highly functional connection to one of the assemblies if the clamping lever, in particular its two spaced clamping lever limbs has a first clamping lever portion coupled to the clamping element and a second clamping lever portion extending at an angle relative to the first clamping lever portion and preferably a third clamping lever portion which extends at an angle relative to the second clamping lever portion and at the distal end of which the handle is fixed. The angles can preferably be so selected that the lever permits the application of a good torque and at the same time preferably good mechanical actuation is possible with sufficient space and without the hand being trapped.

It is particularly advantageous in regard to reliable secure bracing if the clamping lever is mounted pivotably to the first assembly or the second assembly of the pelletizing apparatus in such a way that the clamping lever moves beyond a dead center point in the manner of a toggle lever in the clamping operation and/or self-locking clamping ensues.

The invention has been described hereinbefore with reference to a quick-action clamping apparatus. In a further aspect the invention concerns a pelletizing apparatus for the production of pellets from a melt flow, comprising a pelletizer and a cutting chamber.

The invention attains the object set forth in the opening part of this specification in relation to the pelletizing apparatus by same having a quick-action clamping apparatus having a clamping means for bracing the pelletizer and the cutting chamber.

A development of the invention provides that the quick-action clamping apparatus is designed in accordance with one of the above-described preferred embodiments.

The pelletizing apparatus makes use of the same advantages and preferred configurations as the quick-action clamping apparatus according to the invention. In that respect attention is directed to the foregoing description and the content thereof is hereby incorporated.

In a further aspect the invention concerns a method of bracing a first assembly of a pelletizing apparatus to a second assembly of the pelletizing apparatus, in particular a pelletizer to a cutting chamber or a cutting chamber to an apertured plate.

The invention attains the object set forth in the opening part of this specification in relation to the method with the steps: providing the first assembly, in particular a pelletizer or an apertured plate; providing the second assembly, in particular a cutting chamber; and bracing the first assembly to the second assembly by means of a quick-action clamping apparatus, wherein the quick-action clamping apparatus is designed in accordance with one of the above-indicated and described embodiments.

The invention makes use of the same advantages and preferred embodiments as the quick-action clamping apparatus according to the invention. In that respect attention is directed to the foregoing description and the content thereof is hereby incorporated.

An advantageous development of the method provides that the clamping means is actuated by means of a clamping lever connected to the at least one clamping element, and the clamping lever is mounted pivotably to the first assembly or the second assembly of the pelletizing apparatus in the manner of a toggle lever and is rotated beyond a dead center point for the bracing effect and a self-locking bracing effect ensues.

In a further advantageous development for releasing the clamping action a force is applied to the locking element and thereby the first assembly is released from the second assembly, preferably at least somewhat spaced therefrom.

According to a further aspect to attain the object the invention further concerns a clamping lever which can be coupled to a clamping element for actuation of the clamping element of a quick-action clamping apparatus according to the invention for bracing a first assembly of a pelletizing apparatus to a second assembly of the pelletizing apparatus. According to the invention it is provided that the clamping lever has two spaced clamping lever limbs and a handle connecting the clamping lever limbs.

Additionally, or alternatively it is proposed that the clamping lever, in particular the two spaced clamping lever limbs thereof, has a first clamping lever portion coupled to the clamping element and a second clamping lever portion extending at an angle relative to the first clamping lever portion.

In regard to the further advantages and preferred features of the clamping element reference is directed to the foregoing and following description.

### BRIEF DESCRIPTION OF THE DRAWINGS

The invention is described in greater detail hereinafter by means of preferred embodiments by way of example with reference to the accompanying Figures.

In the Figures:

FIGS. 1 and 2 show perspective views of a first embodiment by way of example of a pelletizing apparatus according to the invention,

FIG. 3 shows a plan view of the embodiment of the pelletizing apparatus according to the invention as shown in FIGS. 1 and 2,

FIG. 4 shows a detail view of the cutting chamber of the first embodiment of FIGS. 1 to 3,

FIG. 5 shows a perspective view of a clamping element according to the invention of the first embodiment,

FIG. 6 shows a perspective detail view of the pelletizing apparatus according to the invention according to the first embodiment,

FIGS. 7 and 8 show perspective views of an alternative embodiment of a pelletizing apparatus according to the invention,

FIG. 9 shows a plan view of the alternative embodiment of the pelletizing apparatus according to the invention shown in FIGS. 7 and 8,

FIG. 10 shows a detail view of the cutting chamber of the alternative embodiment of FIGS. 7 to 9,

FIG. 11 shows a perspective view of a clamping element according to the invention in accordance with the alternative embodiment,

FIG. 12 shows a perspective detail view of the pelletizing apparatus according to the invention in accordance with the alternative embodiment, and

FIG. 13 shows a further alternative embodiment of a quick-action clamping apparatus according to the invention.

### DETAILED DESCRIPTION OF ILLUSTRATIVE EMBODIMENTS

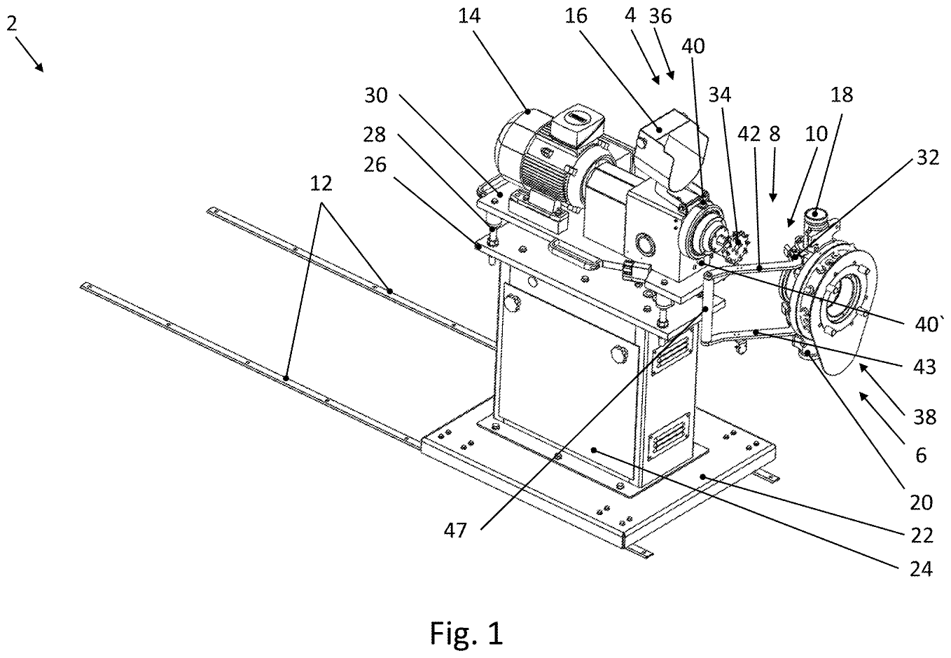

FIG. 1 shows a pelletizing apparatus 2 for the production of pellets from a melt flow. The pelletizing apparatus 2 has a pelletizer 4 and a cutting chamber 6. The cutting chamber 6 is arranged stationarily. The pelletizer 4 is arranged moveably on pelletizer rails 12 in such a way that the pelletizer 4 can be moved in the direction of the cutting chamber 6 and can be coupled thereto.

The pelletizer 4 has a base portion 22 on which a housing 24 is arranged. Arranged at the top side of the housing 24 is a base plate 26 at which a machine carrier 30 is disposed by means of spacer elements 28. Disposed on the machine carrier 30 is a drive 14 driving a cutting blade 34. The pelletizer 4 further has a protective hood 16. The pelletizer 4 is a first assembly 36.

Arranged on the pelletizer 4 are locking elements 40, 40′, in particular in that region of the pelletizer 4, that is coupled to the cutting chamber 6. The locking elements 40, 40′ are part of a quick-action clamping apparatus 8.

The cutting chamber 6 is a second assembly 38. The cutting chamber 6 has an inlet for process water 20 and an outlet 18 for process water and pellets. Pelletization and cutting of a supplied melt is effected in the cutting chamber 6, in which case both process water and also pellets issue from the cutting chamber 6 from the outlet 18.

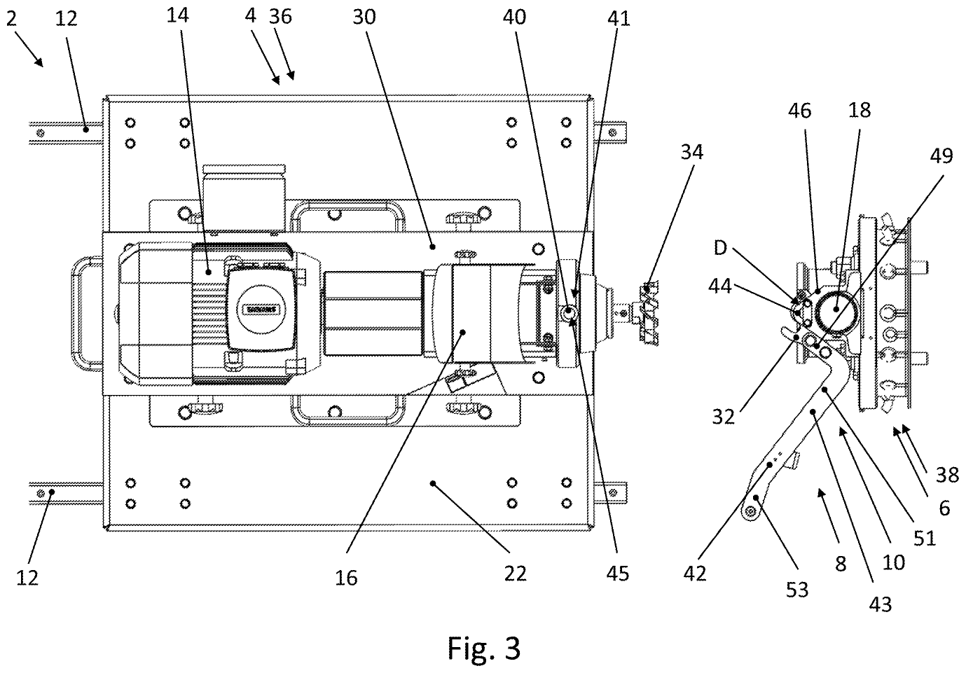

A clamping means 10 is arranged at the cutting chamber 6. The clamping means 10 has a clamping element 32. The clamping element 32 is mounted rotatably to a mounting element 44 (see FIG. 3). The clamping means 10 has a clamping lever 42 connected to the clamping element 32.

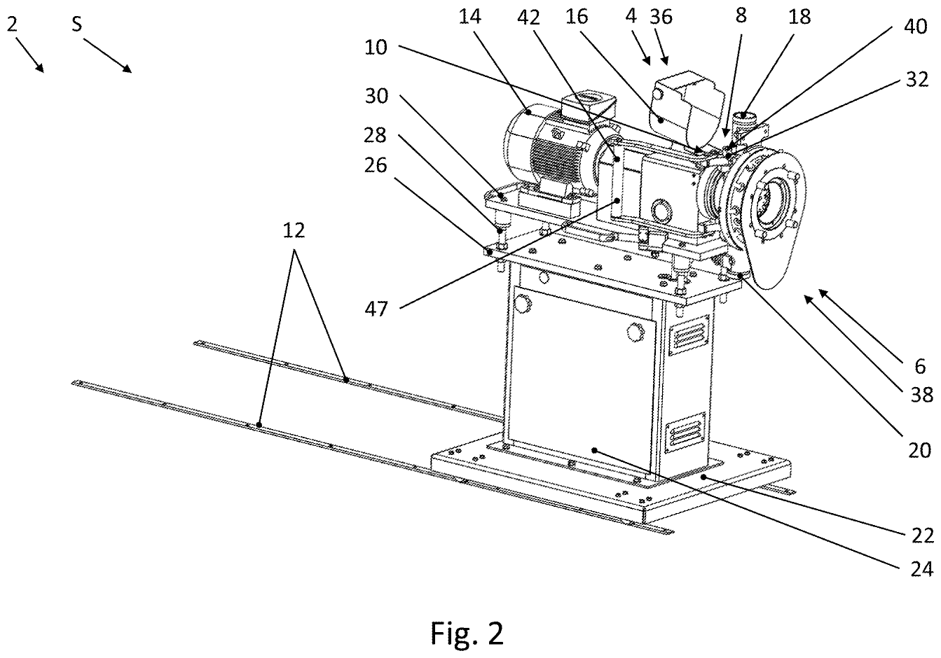

FIG. 2 shows the pelletizing apparatus 2 of FIG. 1, with the clamping means 10 here being in a clamping position S. In the clamping position S, the pelletizer 4 is braced to the cutting chamber 6 by means of the quick-action clamping apparatus 8. In that situation the clamping element 32 is in engagement with the locking element 40 and braces the first assembly 36 against the second assembly 38. Further details in that respect are shown in FIG. 3.

FIG. 3 shows a plan view of the pelletizing apparatus 2 including the pelletizer 4 and the cutting chamber 6. As can be seen from FIG. 3 at its top side in the region adjacent to the cutting blade 34 the pelletizer 4 has the locking element 40 which has an external cross-section indicated at 41. The locking element 40 is in the form of a pin 45. The clamping element 32 arranged at the cutting chamber 6 is mounted on a mounting element 44 rotatably about an axis of rotation D. The clamping lever 42 is connected to the clamping element 32. A pivotal movement of the clamping lever 42 provides that the clamping element 32 connected to the clamping lever 42 rotates about the axis of rotation D. The mounting element 44 is arranged at a pin holder 46 connected to the cutting chamber 6. The clamping element 32 is adapted after the movement of the pelletizer 4 in the direction of the cutting chamber 6 to come into engagement with the locking element 40 and to be pivoted into the clamping position S shown in FIG. 2.

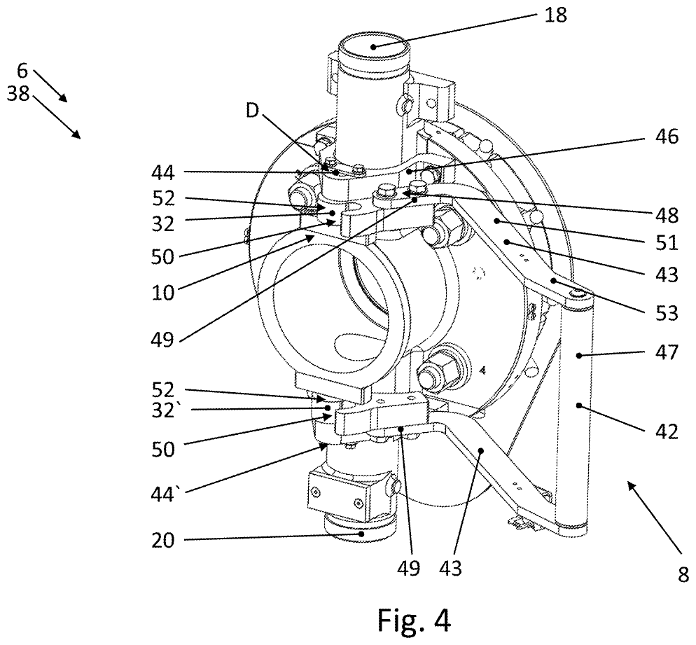

FIG. 4 shows a perspective view of the cutting chamber 6. The cutting chamber 6 has essential parts of the quick-action clamping apparatus 8. The quick-action clamping apparatus 8 has the first clamping element 32 and a second clamping element 32′. Both clamping elements 32, 32′ are connected to the clamping lever 42 by means of a connecting screw 48. A movement of the clamping lever 42 also results in a movement of the two clamping elements 32, 32′.

As already stated in relation to FIG. 3 the clamping element 32 is mounted to the mounting element 44 about the axis of rotation D. The mounting element 44 is arranged on the pin holder 46. The clamping element 32′ is mounted to the mounting element 44 rotatably about an axis of rotation (not shown). The clamping elements 32, 32′ each have a respective hooked portion 50. In addition, the clamping elements 32, 32′ have an eccentric portion 52. The eccentric portion 52 is of such a configuration that, in the movement of the clamping elements 32, 32′ out of the clamping position S shown in FIG. 2, the eccentric portion exerts a force on the locking elements 40, 40′. As a result, the first assembly 36 is separated from the second assembly 38 (see FIG. 2).

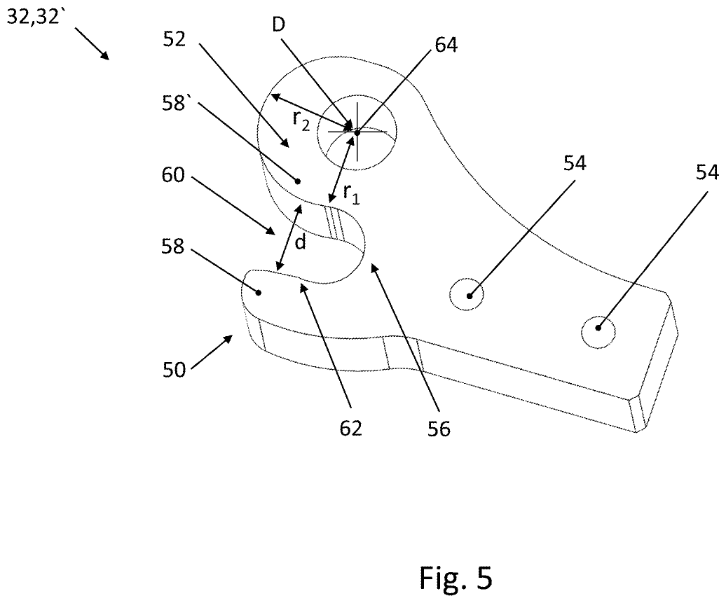

FIG. 5 shows a clamping element 32, 32′. The clamping element 32, 32′ can be connected to the clamping lever 42 by means of the threaded bore 54 (see for example FIG. 4). Alternatively, the clamping element 32, 32′ and the clamping lever 42 can be formed in one piece. The clamping element 32, 32′ has a hooked portion 50. The hooked portion 50 is formed by a hook bottom 56 as well as a first limb 58 and a second limb 58′. The limbs 58, 58′ define a hook mouth 60. The hook mouth 60 forms a free cross-section d between the limbs 58, 58′. The free cross-section d enlarges from the hook bottom 56 in the direction of the limbs 58, 58′. In the present case the first limb 58 has a thickening 62. The thickening 62 is arranged adjacent to the hook bottom 56. The thickening 62 is adapted to hold the locking element 40 (see for example FIG. 3) in the clamping position S. Alternatively, the first limb 58 can be of an angled configuration such that it holds the locking element 40 (see FIG. 3) in the clamping position S in a self-locking relationship.

The clamping element 32, 32′ further has an eccentric portion 52. The eccentric portion 52 is of such a configuration that, in the movement of the clamping element 32, 32′ out of the clamping position S, it exerts a force on the locking element 40, 40′ (see FIG. 3). The eccentric portion 52 has an area centroid 64 corresponding to the axis of rotation D of the clamping element 32, 32′. The eccentric portion 52 forms the limb 58′. In the region of the hook bottom 56 the eccentric portion 52 has a first radius r₁ which is smaller than a radius r₂ which is to be found on the second limb 58′ further away from the hook bottom 56. The increase in radius between the radius r₁ and the radius r₂ is linear, optionally non-linear.

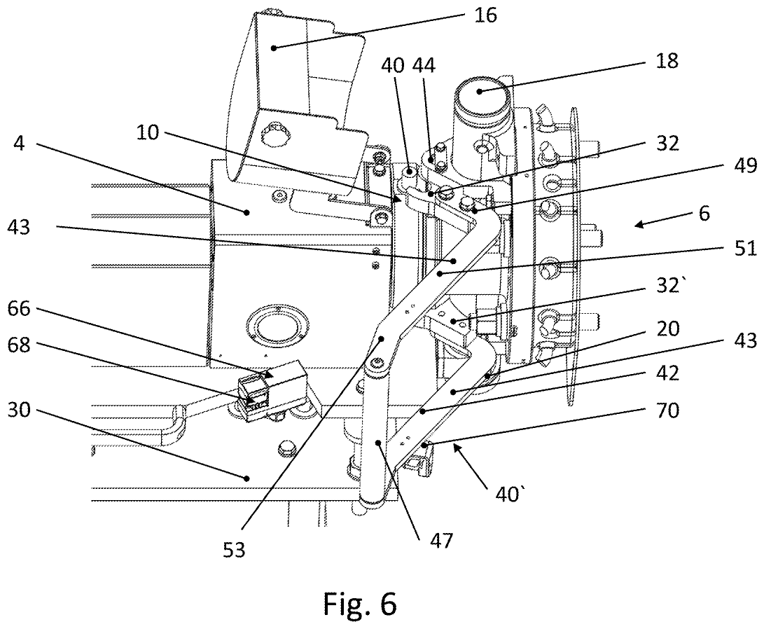

FIG. 6 shows a detail view of the pelletizer 4 and the cutting chamber 6 in a coupled but non-locked state. Arranged on the pelletizer 4 adjacent to the machine carrier 30 is a sensor device 66. The sensor device 66 is adapted to generate a signal when the clamping means 10 or the clamping lever 42 is moved out of the clamping position S (see FIG. 2). The generated signal can be used for example to stop the pelletizer, to start it, or to prevent operation of the pelletizer 4 when the clamping means 10 and the clamping lever 42 are in the position shown in FIG. 6.

In addition, a locking device 68, in particular an electromechanical locking device 68, is arranged on the pelletizer 4. The locking device 68 is adapted to selectively hold fast or release a locking means 70 arranged on the clamping lever 42. In other words, the locking device 68 ensures that, when the clamping means 10 is in the clamping position S and the pelletizer 4 as well as the cutting chamber 6 are being operated, the clamping lever 42 cannot be moved out of the clamping position S, for example inadvertently. As soon as the pelletizer 4 and the cutting chamber 6 are no longer in operation the locking device 68 is adapted to release the clamping lever 42 and therewith the clamping means 10. The clamping lever 42 can now be moved out of the clamping position S.

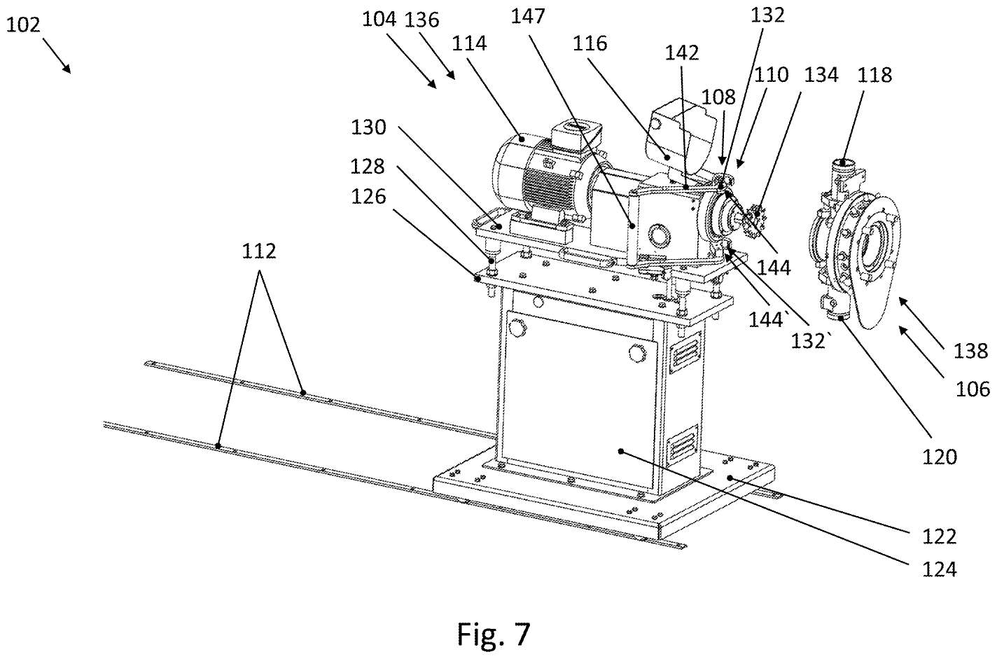

FIGS. 7 to 12 show an alternative embodiment of a pelletizing apparatus 102. The pelletizing apparatus 102 has a pelletizer 104 and a cutting chamber 106. The cutting chamber 106 is arranged stationarily. The pelletizer 4 is arranged moveably on pelletizer rails 112. The pelletizing apparatus 102 has a quick-action clamping apparatus 108. The quick-action clamping apparatus 108 has a clamping means 110, with two clamping elements 132, 132′.

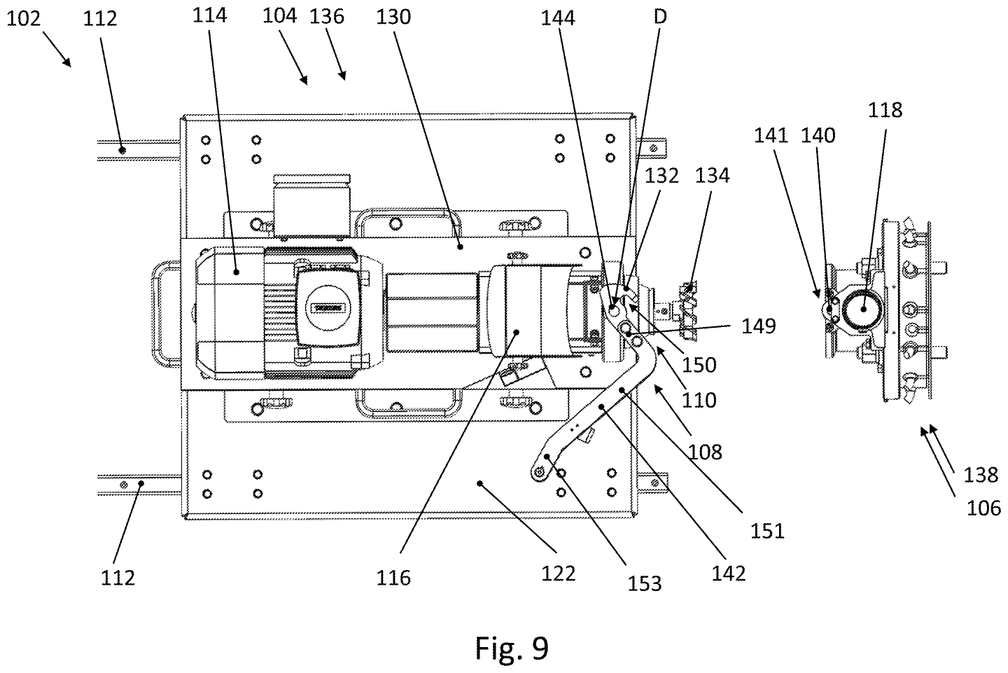

In contrast to the first embodiment of FIGS. 1 to 6 the clamping elements 132, 132′ are now arranged at the pelletizer 104. Equally locking elements 140, 140′ (see FIG. 9) are now arranged at the cutting chamber 106.

The pelletizer 104 has a base portion 122 and a housing 124 in a structure which is already known. Disposed at the top side of the housing 124 is a base plate 126, above which is arranged a machine carrier 130 spaced from the base plate 126 by spacer elements 128. Arranged on the machine carrier 130 is a drive 114 which drives a cutting blade 134 in rotation. The pelletizer 104 further has a protective hood 116. The clamping elements 132, 132′ are respectively mounted to a mounting element 144, 144′. The clamping means 110 further has a clamping lever 142 connected to the clamping elements 132, 132′ for actuating the clamping elements 132, 132′. The pelletizer 104 is a first assembly 136; the cutting chamber 106 is a second assembly 138.

The cutting chamber 106 has an inlet 120 for process water which feeds process water to the cutting chamber 106 and an outlet 118 for process water and pellets from which process water and pellets issue from the cutting chamber 106. In FIG. 7 the pelletizer 104 and the cutting chamber 106 are shown separated from each other. Maintenance operations on the pelletizer 104 and/or the cutting chamber 106 can be performed in the illustrated operative position.

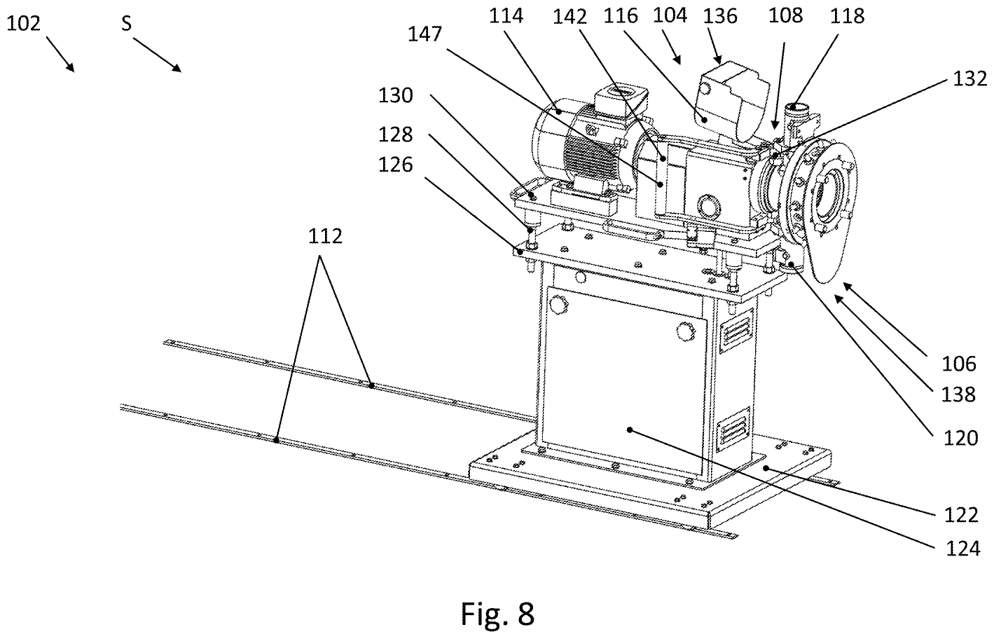

FIG. 8 shows the components described with reference to FIG. 7 in a clamping position S. The pelletizer 104 is now coupled to the cutting chamber 106. The clamping elements 32, 32′ (see FIG. 7) are in the clamping position S. The clamping elements 132, 132′ are in engagement with locking elements 140, 140′ (see FIG. 9) and brace the first assembly 136 to the second assembly 138.

FIG. 9 shows a plan view of the pelletizing apparatus 102. In relation to the cutting chamber 106 it is now possible to see the locking element 140 arranged at the top side thereof. The locking element 140 has an external cross-section indicated at 141. Referring to the pelletizer 4 the components which are visible from above of the quick-action clamping apparatus 108, including the clamping means 110, can be seen there. The clamping element 132 is mounted to a mounting element 144 rotatably about an axis of rotation D. The clamping element 132 has a hooked portion 150. That hooked portion 150 is of a configuration corresponding to the external cross-section 141 of the locking element 140 in such a way that, in the pivotal movement of the clamping element 132 into the clamping position S, the portion 150 comes into engagement with the locking element 140 and braces the locking element 140 against the clamping element 132 in the clamping position S.

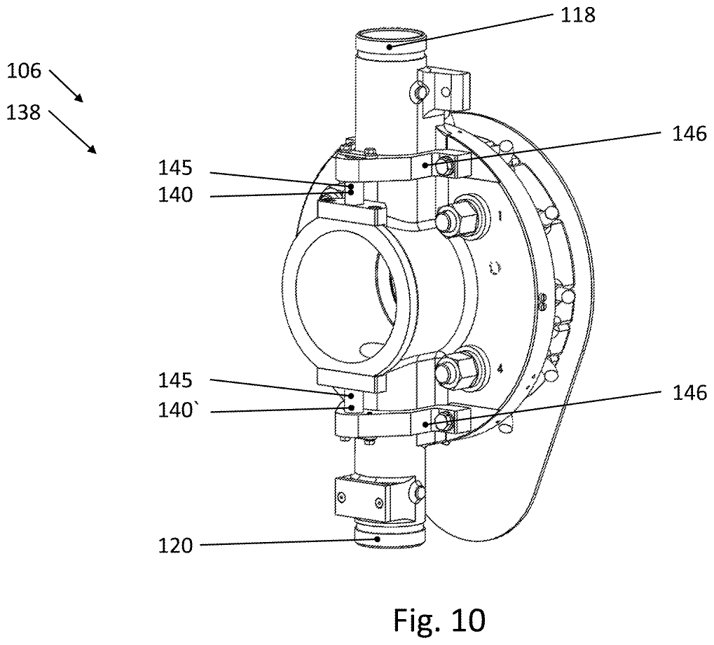

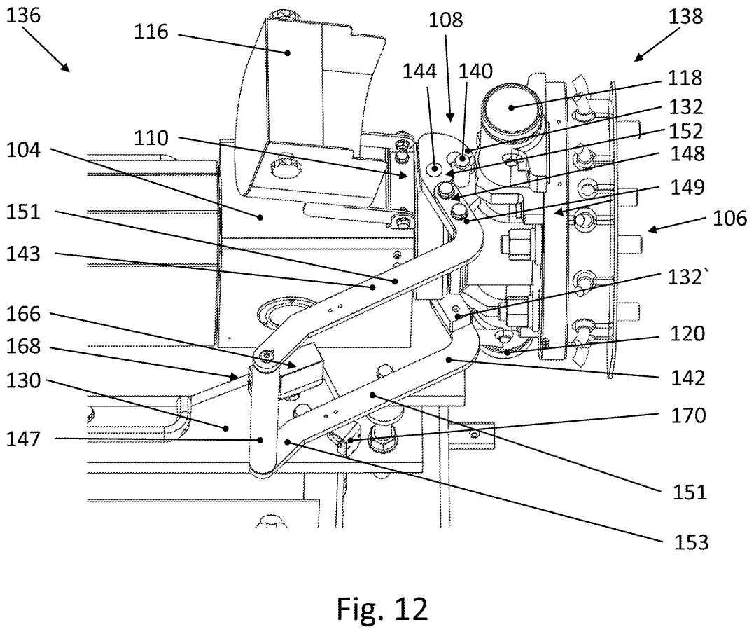

FIG. 10 shows a detail view of the cutting chamber 106 which represents the second assembly 138. The cutting chamber 106 has the inlet 120 for process water and the outlet 118 for process water and pellets in known manner. Pin holders 146 are respectively arranged adjacent to the outlet 118 and the inlet 120. Arranged at the pin holders 46 is a respective locking element 140, 140′. The clamping elements 132, 132′ (see FIG. 12) come into engagement with the locking elements 140, 140′ in the clamping position S.

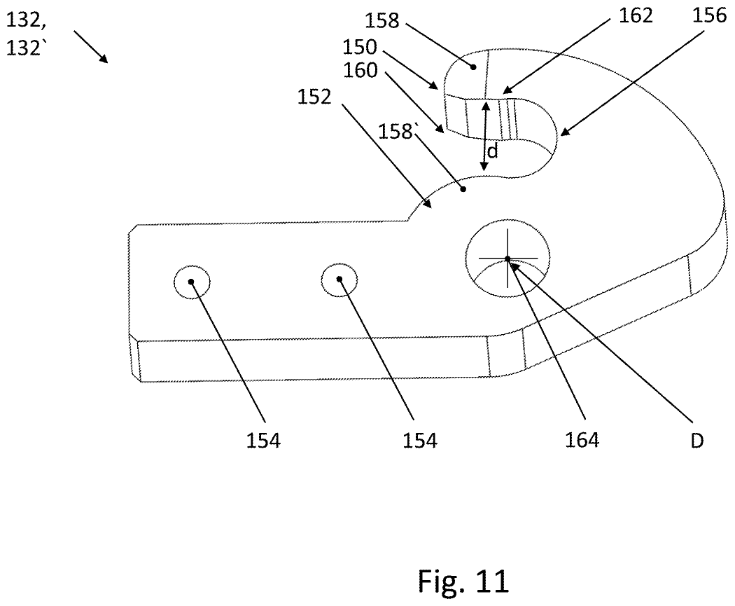

FIG. 11 shows a detail view of the clamping element 132, 132′. The clamping element 132, 132′ has threaded bores 154 for fixing the clamping element 132, 132′ to the clamping lever 142. The clamping element 132, 132′ has the hooked portion 150. The hooked portion 150 has a hook bottom 156, the hook bottom 156 being of a configuration corresponding to the external cross-section 141 of the locking element 140 (see FIG. 10). The locking elements 140, 140′ are in the form of pins 145. The hooked portion 150 further has a first limb 158 and a second limb 158′. The limbs 158, 158′ extends from the hook bottom 156 and form a hook mouth 160. The hook mouth 160 forms a free cross-section d between the limbs 158, 158′. The free cross-section d enlarges from the hook bottom 156 in the direction of the limbs 158, 158′.

The first limb 158 has a thickening 162. The thickening 162 is arranged adjacent to the hook bottom 156. The thickening 162 is adapted to hold the locking element 140, 140′ (see FIG. 8) in the clamping position S. The first limb 158 can alternatively be of an angled configuration, in particular with a shallow angle, in such a way that it holds the locking element 140, 140′ (see FIG. 8) in the clamping position S in self-locking relationship. The clamping element 132, 132′ further has an eccentric portion 152. The configuration of the eccentric portion 152 is such that, in the movement of the clamping element 132, 132′ out of the clamping position S, it exerts a force on the locking element 140, 140′ (see FIG. 8). The eccentric portion 152 has an area centroid 164 corresponding to the axis of rotation D of the clamping element 132, 132′. The limb 158′ is formed by the eccentric portion 152.

FIG. 12 shows the cutting chamber 106 and the quick-action clamping apparatus 108 in a coupled state in which however it is not yet completely braced. The clamping elements 132, 132′ are in engagement with the locking elements 140, 140′ (lower locking element 140′ is not visible). When, starting from the position shown in FIG. 12, the clamping lever 142 is moved in the direction of the pelletizer 104 then the clamping element 132 comes further into engagement with the locking element 140 and braces the first assembly 136 to the second assembly 138. When, however, the clamping lever 142 is moved in the opposite direction away from the pelletizer 104 in the direction of the cutting chamber 106 then the eccentric portion 152 of the clamping element 132 urges the locking element 140 away from the pelletizer 104. The consequence of this is that the pelletizer 104 which is mounted moveably is urged away from the stationarily arranged cutting chamber 106. That facilitates uncoupling the first assembly 136 from the second assembly 138 by a movement of the clamping lever 142.

The pelletizer 104 has a sensor device 166 adapted to sense the position of the clamping lever 142. In addition, the pelletizer 104 has an electromechanical locking device 168 adapted to selectively hold or release the locking means 170 when the clamping means 110 is in the clamping position S.

Further features of the clamping levers can be seen for both embodiments from the Figures, in particular FIGS. 3, 4, 6, 9 and 12. The clamping lever 42, 142 has two spaced clamping lever limbs 43, 143 and a handle 47, 147 connecting the clamping lever limbs 43, 143.

The clamping lever 42, 142, in particular the two spaced clamping lever limbs 43, 143 thereof, has a first clamping lever portion 49, 149 coupled to the clamping element 32, 32′, 132, 132′, and a second clamping lever portion 51, 151 extending at an angle relative to the first clamping lever portion 49, 149, and preferably a third clamping lever portion 53, 153 which extends at an angle relative to the second clamping lever portion 51, 151 and at the distal end of which is fixed the handle 47, 147. The clamping lever 42, 142 is thus pivotably mounted to the first assembly 36, 136 or the second assembly 38, 138 of the pelletizing apparatus 2, 102 in such a way that the clamping lever 42, 142 passes beyond a dead center point in the bracing operation in the manner of a toggle lever and a self-locking bracing action ensues.

As can be clearly seen for example from FIGS. 3 and 9 the first clamping lever portion 49 is shorter than and is at an angle of about 90° relative to the second clamping lever portion 51, 151. The first clamping lever portion 49, 149 is preferably releasably connected to the clamping element 32, 32′, 132, 132′ by means of the threaded bores 54. The angle between the first and second clamping lever portions 49, 149, 51, 151 and also the respective lengths in the respective axial direction could vary and assume different ranges of values. The angle between the second clamping lever portion 49, 149, 51, 151 and the third clamping lever portion 53, 153 is markedly greater than 90°, in the illustrated embodiment approximately in the region of 170°, but it would also be possible to implement an angular range of for example between 180° and 90°. The third clamping lever portion 53, 153 is so selected that the handle 47, 147 fixed to the two clamping lever portions 49, 149 can be readily gripped, even and in particular in the clamping position S, so that a hand or finger can pass between the handle 47, 147 and the oppositely disposed assembly, in particular a pelletizer 4, 104 or a cutting chamber 6, 106, and the hand is not trapped. Very roughly the clamping lever limbs in the plan view (FIG. 3, FIG. 9) bear a similarity to an S-shape.

The method according to the invention and the mode of operation of the quick-action clamping apparatus and the components thereof are further described hereinafter:

For bracing a pelletizer 4, 104 shown by way of example to a cutting chamber 6, 106 (other assemblies are also included in accordance with the invention) firstly the pelletizer 4, 104 and the cutting chamber 6, 106 are provided in mutually relative relationship (FIGS. 1, 3, 6, 9 and 12). Then the quick-action clamping apparatus is actuated, either by means of drive means or manually, so that the clamping means 10, 110 come into engagement with the clamping element 32, 132 relative to the locking element 40, 140 and the first and second assemblies 36, 136, 38, 138 are braced relative to each other. During that rotary movement, in the illustrated embodiment by actuation of the handle 47, 147, the clamping lever which is designed in the manner of a toggle lever passes over a dead center point at which the relative bracing is at a maximum and then passes by further rotary movement beyond that dead center point, during which the bracing decreases somewhat. As a result, a self-locking bracing action is achieved in that region. In the clamping position the handle 47, 147 is arranged at a minimum spacing in relation to the pelletizing apparatus 2, 102. The spacing is so selected by virtue of the above-described configuration that a hand can engage between the pelletizing apparatus 2, 102 and the handle 47, 147 without being trapped. For release purposes the clamping element 32, 32′, 132, 132′ is rotated in the opposite direction and during the rotation in that direction a force is applied to the locking element 40, 40′, 140, 140′ by the eccentric portion 52, 152 of the clamping element 32, 32′, 132, 132′ so that the first and second assemblies 36, 136, 38, 138 are released relative to each other and preferably at least partially spaced from each other.

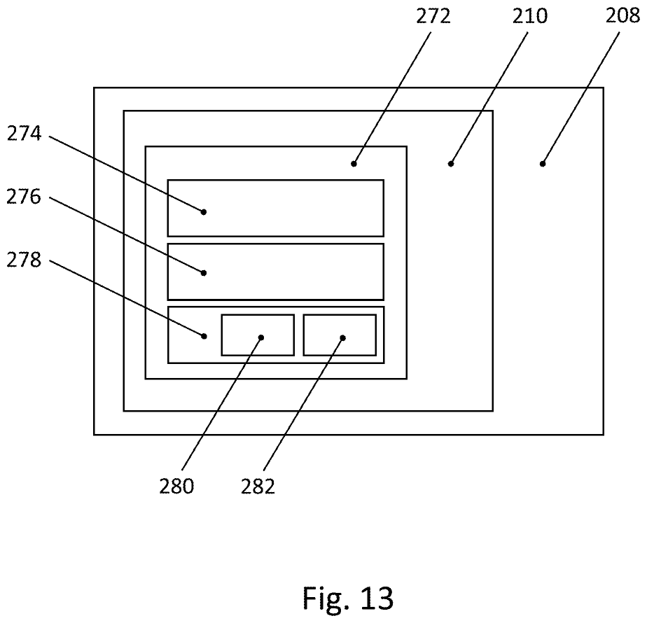

FIG. 13 shows a block circuit diagram of a further embodiment of a quick-action clamping apparatus 208. The quick-action clamping apparatus 208 has a clamping means 210. A drive device 272 is arranged at the clamping means 210. The drive device 272 serves to drive the clamping means 210. The drive device 272 has an electric motor 274, a hydraulic actuator 276 and/or a pneumatic drive 278. The pneumatic drive 278 has a cylinder drive 280 and/or a rotary drive 282.

### LIST OF REFERENCES

2 pelletizing apparatus
4 pelletizer
6 cutting chamber
8 quick-action clamping apparatus
10 clamping means
12 pelletizer rails
14 drive
16 protective hood
18 outlet for process water and pellets
20 inlet for process water
22 base portion
24 housing
26 base plate
28 spacer elements
30 machine carrier
32, 32′ clamping element
34 cutting blade
36 first assembly
38 second assembly
40, 40′ locking element
41 external cross-section of the locking element
42 clamping lever
43 clamping lever limb
44, 44′ mounting element
45 pin
46 pin holder
47 handle
48 connecting screws
49 first clamping lever portion
50 hooked portion
51 second clamping lever portion
52 eccentric portion
53 third clamping lever portion
54 threaded bores
56 hook bottom
58, 58′ first limb, second limb
60 hook mouth
62 thickening
64 area centroid
66 sensor device
68 electromechanical locking device
70 locking means
102 pelletizing apparatus
104 pelletizer
106 cutting chamber
108 quick-action clamping apparatus
110 clamping means
112 pelletizer rails
114 drive
116 protective hood
118 outlet for process water and pellets
120 inlet for process water
122 base portion
124 housing
126 base plate
128 spacer elements
130 machine carrier
132, 132′ clamping element
134 cutting blade
136 first assembly
138 second assembly
140, 140′ locking element
141 external cross-section of the locking element
142 clamping lever
143 clamping lever limb
144, 144′ mounting element
145 pin
146 pin holder
147 handle
148 connecting screws
149 first clamping lever portion
150 hooked portion
151 second clamping lever portion
152 eccentric portion
153 third clamping lever portion
154 threaded bores
156 hook bottom
158, 158′ first limb, second limb
160 hook mouth
162 thickening
164 area centroid
166 sensor device
168 electromechanical locking device
170 locking means
208 quick-action clamping apparatus
210 clamping means
272 drive device
274 electric motor
276 hydraulic actuator
278 pneumatic drive
280 cylinder drive
282 rotary drive
d free cross-section
D axis of rotation
S clamping position

1. A quick-action clamping apparatus, in particular a one-hand quick-action clamping apparatus, for bracing a first assembly of a pelletizing apparatus to a second assembly of the pelletizing apparatus, in particular a pelletizer to a cutting chamber or a cutting chamber to an apertured plate,
characterized by:
a mounting element which is arranged at the first assembly or the second assembly,
a locking element which is arranged at the other of the first assembly or the second assembly, and
a clamping means having a clamping element, wherein the clamping element is mounted rotatably about an axis of rotation to the mounting element and the clamping element is adapted to be pivoted into a clamping position (S) in which the clamping element is in engagement with the locking element and braces the first assembly against the second assembly.

2. A quick-action clamping apparatus according to claim 1
characterized by
a second mounting element arranged at the same assembly as the first mounting element,
a second locking element arranged at the same assembly as the first locking element,
wherein the clamping means has a second clamping element which is mounted rotatably about a second axis of rotation (D) to the second mounting element and the second clamping element is adapted together with the first clamping element to be pivoted into the clamping position (S) in which the second clamping element is in engagement with the second locking element.

3. A quick-action clamping apparatus according to claim 1
characterized in that the clamping means further has a clamping lever connected to the at least one clamping element for actuating the at least one clamping element.

4. A quick-action clamping apparatus according to claim 1
characterized in that the at least one clamping element has a hooked portion, wherein the hooked portion is adapted upon a pivotal movement of the clamping element into the clamping position (S) to come into engagement with the locking element and to brace the locking element against the clamping element in the clamping position (S).

5. A quick-action clamping apparatus according to claim 4
characterized in that the hooked portion has a hook bottom, wherein the hook bottom is of a configuration corresponding to an external cross-section of the locking element.

6. A quick-action clamping apparatus according to claim 5
characterized in that the hooked portion has a first limb and a second limb, wherein the limbs extend from the hook bottom and form a hook mouth and wherein the hook mouth forms a free cross-section (d) between the limbs, which enlarges from the hook bottom in a direction of the limbs.

7. A quick-action clamping apparatus according to claim 6 characterized in that the first limb and/or the second limb has a thickening which is arranged adjacent to the hook bottom and is adapted to hold the locking element in the clamping position (S).

8. A quick-action clamping apparatus according to claim 1
characterized in that the clamping element further has an eccentric portion, the eccentric portion being of such a configuration that in the movement of the clamping element out of the clamping position (S) the eccentric portion applies a force to the locking element which separates the first assembly from the second assembly.

9. A quick-action clamping apparatus according to claim 8
characterized in that the eccentric portion has an area centroid corresponding to the axis of rotation (D) of the clamping element.

10. A quick-action clamping apparatus according to claim 8
characterized in that one of the limbs is formed by the eccentric portion.

11. A quick-action clamping apparatus according to claim 1
characterized in that the locking element and/or the mounting element is in the form of a pin.

12. A quick-action clamping apparatus according to claim 1
characterized by a drive device for driving the clamping means, wherein the drive device has or is formed from in particular at least one of the following:
an electric motor,
a hydraulic actuator, or
a pneumatic drive, in particular having a cylinder drive and/or a rotary drive.

13. A quick-action clamping apparatus according to claim 1
characterized by a sensor device for sensing the position of the clamping means.

14. A quick-action clamping apparatus according to claim 13
characterized in that the sensor device is arranged at the pelletizer and/or is adapted to generate a signal when the clamping means is in the clamping position (S) and/or is moved out of same.

15. A quick-action clamping apparatus according to claim 1
characterized by a locking means, in particular an electromechanical locking means, adapted to hold the clamping means in the clamping position (S) and/or to release same from the clamping position (S).

16. A quick-action clamping apparatus according to claim 3
characterized in that the clamping lever has two spaced clamping lever limbs and a handle connecting the clamping lever limbs.

17. A quick-action clamping apparatus according to claim 3
characterized in that the clamping lever, in particular its two spaced clamping lever limbs has a first clamping lever portion coupled to the clamping element and a second clamping lever portion extending at an angle relative to the first clamping lever portion and preferably a third clamping lever portion which extends at an angle relative to the second clamping lever portion and at the distal end of which the handle is fixed.

18. A quick-action clamping apparatus according to claim 3
characterized in that the clamping lever is mounted pivotably to the first assembly or the second assembly of the pelletizing apparatus in such a way that the clamping lever moves beyond a dead center point in the manner of a toggle lever in the bracing operation and self-locking clamping ensues.

19. A pelletizing apparatus for the production of pellets from a melt flow comprising a pelletizer and a cutting chamber,
characterized by a quick-action clamping apparatus comprising a clamping means for bracing the pelletizer and the cutting chamber.

20. A pelletizing apparatus according to claim 19
characterized in that the quick-action clamping apparatus is in accordance with claim 1.

21. A method of bracing a first assembly of a pelletizing apparatus to a second assembly of the pelletizing apparatus, in particular a pelletizer to a cutting chamber or a cutting chamber to an apertured plate, including the steps:
providing the first assembly, in particular a pelletizer or an apertured plate;
providing the second assembly, in particular a cutting chamber; and
bracing the first assembly to the second assembly by means of a quick-action clamping apparatus, wherein the quick-action clamping apparatus is in accordance with claim 1.

22. A method according to claim 21
wherein the clamping means is actuated by means of a clamping lever connected to the at least one clamping element, and
wherein the clamping lever is mounted pivotably to the first assembly or the second assembly of the pelletizing apparatus in the manner of a toggle lever and is rotated beyond a dead center point for the bracing effect and a self-locking bracing effect ensues.

23. A method according to claim 21
wherein the clamping element further has an eccentric portion adapted in the movement of the clamping element out of the clamping position (S) to apply a force to the locking element, that separates the first assembly from the second assembly,
wherein the clamping element is moved, preferably rotated, for releasing the clamping action and a force is applied to the locking element by the eccentric portion and thereby the first assembly is released from the second assembly and is preferably at least somewhat spaced therefrom.

24. A clamping lever which can be coupled to a clamping element for actuation of the clamping element of a quick-action clamping apparatus for bracing a first assembly of a pelletizing apparatus to a second assembly of the pelletizing apparatus,
characterized in that the clamping lever has two spaced clamping lever limbs and a handle connecting the clamping lever limbs.

25. A clamping lever which can be coupled to a clamping element for actuation of the clamping element of a quick-action clamping apparatus for bracing a first assembly of a pelletizing apparatus to a second assembly of the pelletizing apparatus,
characterized in that the clamping lever, in particular the two spaced clamping lever limbs thereof, has a first clamping lever portion coupled to the clamping element and a second clamping lever portion extending at an angle relative to the first clamping lever portion.

26. A clamping lever according to claim 1
characterized by a third clamping lever portion which extends at an angle relative to the second clamping lever portion and to the distal end of which a handle is fixed.

27. A clamping lever according to claim 1
characterized in that the clamping lever is mounted pivotably to the first assembly or the second assembly of the pelletizing apparatus in such a way that the clamping lever moves beyond a dead center point in the bracing operation in the manner of a toggle lever and self-locking bracing ensues.
